(19) United States
(12) Patent Application Publication
(10) Pub. No.: US 2008/0052055 A1
(43) Pub. Date: Feb. 28, 2008

(54) SYSTEMS, METHODS AND APPARATUS FOR PROTEIN FOLDING SIMULATION

(76) Inventors: Geordie Rose, Vancouver (CA); William G. Macready, West Vancouver (CA); Paul S. Bloudoff, North Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/829,794

(22) Filed: Jul. 27, 2007

Related U.S. Application Data
(60) Provisional application No. 60/834,236, filed on Jul. 28, 2006.

(51) Int. Cl. G06G 7/48

(52) U.S. Cl. 703/11

(57) ABSTRACT

Analog processors such as quantum processors are employed to predict the native structures of proteins based on a primary structure of a protein. A target graph may be created of sufficient size to permit embedding of all possible native multi-dimensional topologies of the protein. At least one location in a target graph may be assigned to represent a respective amino acid forming the protein. An energy function is generated based assigned locations in the target graph. The energy function is mapped onto an analog processor, which is evolved from an initial state to a final state, the final state predicting a native structure of the protein.

### CROSS-REFERENCE TO RELATED APPLICATION

This application claims benefit, under 35 U.S.C. §119(e), of U.S. Provisional Patent Application No. 60/834,236, filed Jun. 28, 2006, which is incorporated herein, by reference, in its entirety.

### BACKGROUND OF THE INVENTION

1. Field of the Invention

The present methods, system and apparatus relate to the simulation of the folding of proteins using an analog processor.

2. Description of the Related Art

A protein is a polymer composed of a chain of amino acids. The primary structure of a protein is the sequence of amino acids in the chain. Proteins naturally fold into unique three-dimensional structures, known as their “native” state, and it is generally believed that it is the three dimensional shape of the protein that is largely responsible for its biological function. The native structure of a protein is particularly important in fields such as drug discovery, where the native structure can assist in, e.g., rational drug design. The native structure of a protein can sometimes be experimentally determined using techniques such as X-ray crystallography and NMR spectroscopy; however, these techniques are time-consuming and relatively expensive and there are classes of proteins for which both techniques cannot be reliably applied. The mechanism of protein folding is not fully understood and techniques for protein structure prediction, that is, the prediction of the native state of a protein based on its primary structure, are being avidly sought by computational biologists and chemists.

Proteins typically contain hundreds or thousands of individual atoms. For molecules of this size, direct simulation of system dynamics by solving the underlying physical equation, known as the Schrodinger equation, is known to be impossible for any conventional digital computer. For this reason, it is necessary to build approximate models to be able to gain insight into protein dynamics. One class of approximate models approximates true protein folding by minimizing the energy of a protein fold, where the protein's amino acids are treated as discrete blocks restricted to points on a rigid lattice. These models are generally called lattice protein folding models.

By introducing an energy function, that is, a set of conditions which specify the energy of interaction between adjacent amino acids, it is possible to mimic the behavior of the protein through the energy function. For example, the energies of particular individual amino acid interactions can be determined and input into the energy function. Thus, it is possible to calculate the energy of a given structure of a series of amino acids from the energy function. The structure of the lattice protein sequence with the lowest energy state is considered to be the native state, and may be determined through global optimization of the energy function.

Even though lattice protein models require fewer computational resources than direct solution of the true underlying physical equations, most realistic lattice protein folding models are formally intractable. For example, in one highly-simplified model, the HP model, the amino acids are divided into just two classes—hydrophobic (H) and hydrophilic (P), with only the hydrophobic effect being modeled via a negative (favorable) interaction between H amino acids. The HP model is known to be NP-complete, and therefore intractable for the analysis of all but very small proteins.

A Turing machine is a theoretical computing system, described in 1936 by Alan Turing. A Turing machine that can efficiently simulate any other Turing machine is called a Universal Turing Machine (UTM). The Church-Turing thesis states that any practical computing model has either the equivalent or a subset of the capabilities of a UTM.

An analog processor is a processor that employs the fundamental properties of a physical system to find the solution to a computation problem. In contrast to a digital processor, which requires an algorithm for finding the solution followed by the execution of each step in the algorithm according to Boolean methods, analog processors do not involve Boolean methods.

A quantum computer is any physical system that harnesses one or more quantum effects to perform a computation. A quantum computer that can efficiently simulate any other quantum computer is called a Universal Quantum Computer (UQC).

In 1981 Richard P. Feynman proposed that quantum computers could be used to solve certain computational problems more efficiently than a UTM and therefore invalidate the Church-Turing thesis. See e.g., Feynman R. P., “Simulating Physics with Computers” International Journal of Theoretical Physics, Vol. 21 (1982) pp. 467-488. For example, Feynman noted that a quantum computer could be used to simulate certain other quantum systems, allowing exponentially faster calculation of certain properties of the simulated quantum system than is possible using a UTM.

There are several general approaches to the design and operation of quantum computers. One such approach is the “circuit model” of quantum computation. In this approach, qubits are acted upon by sequences of logical gates that are the compiled representation of an algorithm. Circuit model quantum computers have several serious barriers to practical implementation. In the circuit model, it is required that qubits remain coherent over time periods much longer than the single-gate time. This requirement arises because circuit model quantum computers require operations that are collectively called quantum error correction in order to operate. Quantum error correction cannot be performed without the circuit model quantum computer's qubits being capable of maintaining quantum coherence over time periods on the order of 1,000 times the single-gate time. Much research has been focused on developing qubits with coherence sufficient to form the basic information units of circuit model quantum computers. See e.g., Shor, P. W. “Introduction to Quantum Algorithms” arXiv.org:quant-ph/0005003 (2001), pp. 1-27. The art is still hampered by an inability to increase the coherence of qubits to acceptable levels for designing and operating practical circuit model quantum computers.

Another approach to quantum computation, called thermally-assisted adiabatic quantum computation, involves using the natural physical evolution of a system of coupled quantum systems as a computational system. This approach does not make critical use of quantum gates and circuits. Instead, starting from a known initial Hamiltonian, it relies upon the guided physical evolution of a system of coupled quantum systems wherein the problem to be solved has been encoded in the system's Hamiltonian, so that the final state of the system of coupled quantum systems contains information relating to the answer to the problem to be solved. This approach does not require long qubit coherence times. Examples of this type of approach include adiabatic quantum computation, cluster-state quantum computation, one-way quantum computation, and quantum annealing, and are described, for example, in Farhi, E. et al., “Quantum Adiabatic Evolution Algorithms versus Simulated Annealing” arXiv.org:quant-ph/0201031 (2002).

As mentioned previously, qubits can be used as fundamental units of information for a quantum computer. As with bits in UTMs, qubits can refer to at least two distinct quantities; a qubit can refer to the actual physical device in which information is stored, and it can also refer to the unit of information itself, abstracted away from its physical device.

Qubits generalize the concept of a classical digital bit. A classical information storage device can encode two discrete states, typically labeled “0” and “1”. Physically these two discrete states are represented by two different and distinguishable physical states of the classical information storage device, such as direction or magnitude of magnetic field, current or voltage, where the quantity encoding the bit state behaves according to the laws of classical physics. A qubit also contains two discrete physical states, which can also be labeled “0” and “1”. Physically these two discrete states are represented by two different and distinguishable physical states of the quantum information storage device, such as direction or magnitude of magnetic field, current or voltage, where the quantity encoding the bit state behaves according to the laws of quantum physics. If the physical quantity that stores these states behaves quantum mechanically, the device can additionally be placed in a superposition of 0 and 1. That is, the qubit can exist in both a “0” and “1” state at the same time, and so can perform a computation on both states simultaneously. In general, N qubits can be in a superposition of 2^{N} states. Quantum algorithms make use of the superposition property to speed up some computations.

In standard notation, the basis states of a qubit are referred to as the |0> and |1> states. During quantum computation, the state of a qubit, in general, is a superposition of basis states so that the qubit has a nonzero probability of occupying the 10) basis state and a simultaneous nonzero probability of occupying the |1> basis state. Mathematically, a superposition of basis states means that the overall state of the qubit, which is denoted |Ψ>, has the form |Ψ>=a|0>+b|1>, where a and b are coefficients corresponding to the probabilities |a|² and |b|², respectively. The coefficients a and b each have real and imaginary components. The quantum nature of a qubit is largely derived from its ability to exist in a coherent superposition of basis states. A qubit will retain this ability to exist as a coherent superposition of basis states when the qubit is sufficiently isolated from sources of decoherence.

To complete a computation using a qubit, the state of the qubit is measured (i.e., read out). Typically, when a measurement of the qubit is performed, the quantum nature of the qubit is temporarily lost and the superposition of basis states collapses to either the |0> basis state or the |1> basis state and thus regains its similarity to a conventional bit. The actual state of the qubit after it has collapsed depends on the probabilities |a|² and |b|² immediately prior to the readout operation.

There are many different hardware and software approaches under consideration for use in quantum computers. One hardware approach uses integrated circuits formed of superconducting materials, such as aluminum or niobium. The technologies and processes involved in designing and fabricating superconducting integrated circuits are similar to those used for conventional integrated circuits.

Superconducting qubits are a type of superconducting device that can be included in a superconducting integrated circuit. Superconducting qubits can be separated into several categories depending on the physical property used to encode information. For example, they may be separated into charge, flux and phase devices, as discussed in, for example Makhlin et al., 2001, Reviews of Modern Physics 73, pp. 357-400. Charge devices store and manipulate information in the charge states of the device, where elementary charges consist of pairs of electrons called Cooper pairs. A Cooper pair has a charge of 2e and consists of two electrons bound together by, for example, a phonon interaction. See e.g., Nielsen and Chuang, Quantum Computation and Quantum Information, Cambridge University Press, Cambridge (2000), pp. 343-345. Flux devices store information in a variable related to the magnetic flux through some part of the device. Phase devices store information in a variable related to the difference is superconducting phase between two regions of the phase device. Recently, hybrid devices using two or more of charge, flux and phase degrees of freedom have been developed. See e.g., U.S. Pat. No. 6,838,694 and U.S. Patent Publication No. 2005-0082519, where are hereby incorporated by reference in their entireties.

Since quantum computers large enough to accommodate this number of variables do not yet exist, it may be necessary to decompose problems into subproblems of suitable size for the quantum computer hardware to handle. One possible method of problem decomposition involves a technique called local search. In this technique, a randomly selected subset of variables is minimized while those not in the subset are fixed, and this is repeated until a solution is found. This technique does not guarantee finding a global minimum. To find a global minimum, a different problem decomposition technique may be used such as cut-set conditioning. Cut-set conditioning differs from local search in that the same variables are fixed throughout the computation and all possibilities of these fixed variables are exhausted.

Many lattice protein folding models, whose solution would be highly valuable, are NP-complete and therefore are intractable for conventional digital computers. Accordingly, there remains a need for improved techniques for predicting the native structure of proteins.

### BRIEF SUMMARY OF THE INVENTION

In one embodiment a method for predicting native structures of proteins may be summarized as determining a primary structure of a protein, the primary structure indicative of a linear ordered sequence of a number of amino acids forming the protein; assigning at least one location in a target graph to represent a respective one of the amino acids forming the protein; generating an energy function based at least in part on the at least one assigned location in the target graph; mapping the energy function onto an analog processor; evolving the analog processor from an initial state to a final state; and predicting a native structure representing a multi-dimensional geometry of the protein based at least in part on the final state of the analog processor. The method may further comprise creating the target graph, wherein the target graph has a size sufficient to permit embedding of all possible native multi-dimensional topologies of the protein.

In another embodiment, a computer program product for use with a computer system for predicting native structures of proteins may be summarized as comprising: instructions for determining a primary structure of a protein, the primary structure indicative of a linear ordered sequence of amino acids forming the protein; instructions for assigning at least one location in a target graph to represent a respective one of the amino acids forming the protein; instructions for generating an energy function based at least in part on the at least one assigned location in the target graph; instructions for mapping the energy function onto an analog processor; instructions for initializing the analog processor to an initial state; instructions for evolving the analog processor from the initial state to a final state; and instructions for receiving an output from the analog processor, the output comprising a predicted native structure representing a multi-dimensional geometry of the protein.

In yet another embodiment, a computer system for predicting native structures of proteins may be summarized as comprising: a central processing unit; and a memory, coupled to the central processing unit, the memory storing at least one program module, the at least one program module encoding: instructions for determining a primary structure of a protein, the primary structure indicative of an ordered sequence of a plurality of amino acids forming the protein; instructions for creating a target graph; instructions for assigning at least one location in the target graph to represent a respective one of the amino acids forming the protein; instructions for generating an energy function based at least in part on the at least one assigned location in the target graph; instructions for mapping the energy function onto an analog processor; instructions for initializing the analog processor to an initial state; instructions for evolving the analog processor from the initial state to a final state; and instructions for receiving an output from the analog processor, the output comprising a predicted native structure of the protein, the native structure representing a multi-dimensional geometry of the protein.

In still another embodiment, a computer program product for use with a computer system for predicting native structures of proteins may be summarized as comprising: instructions for determining a primary structure of a protein, the primary structure indicative of an ordered sequence of a plurality of amino acids forming the protein; instructions for creating a target graph; instructions for assigning at least one location in the target graph to represent a respective one of the amino acids forming the protein; instructions for generating an energy function based at least in part on the at least one assigned location in the target graph; instructions for mapping the energy function onto an analog processor; instructions for initializing the analog processor to an initial state; instructions for evolving the analog processor from the initial state to a final state; and instructions for receiving an output from the analog processor, the output comprising a predicted native structure of the protein, the native structure representing a multi-dimensional geometry of the protein.

In yet still another embodiment, a data signal embodied on a carrier wave, comprising a predicted native structure of a protein may be summarized as obtained according to a method comprising: determining a primary structure of a protein, the primary structure indicative of an ordered sequence of a plurality of amino acids forming the protein; creating a target graph; assigning at least one location in the target graph to represent a respective one of the amino acids forming the protein; generating an energy function based at least in part on the at least one assigned location in the target graph; mapping the energy function onto an analog processor; evolving the analog processor from an initial state to a final state; and predicting the native structure of the protein based on the final state of the analog processor, the native structure representing a multi-dimensional geometry of the protein.

### BRIEF DESCRIPTION OF THE SEVERAL VIEWS OF THE DRAWINGS

FIG. 1 is a flow diagram showing a series of acts for simulating the folding of a protein in accordance with an aspect of the present systems, methods and apparatus.

FIGS. 2A through 2E are schematic diagrams illustrating an embodiment of the simulation of the folding of an arbitrary protein into a two-dimensional 8-by-8 grid.

FIGS. 3A through 3E are schematic diagrams illustrating an embodiment of the simulation of the folding of an arbitrary protein into a two-dimensional 4-by-4 grid.

FIGS. 4A and 4B are schematic diagrams showing an existing quantum device and associated energy landscape, respectively.

FIG. 4C is a schematic diagram showing an existing compound junction in which two Josephson junctions are found in a superconducting loop.

FIGS. 5A and 5B are schematic diagrams illustrating exemplary two-dimensional grids of quantum devices in accordance with aspects of the present systems, methods and apparatus.

FIG. 6 is a block diagram of an embodiment of a computing system.

In the figures, identical reference numbers identify similar elements or acts. The sizes and relative positions of elements in the figures are not necessarily drawn to scale. For example, the shapes of various elements and angles are not drawn to scale, and some of these elements are arbitrarily enlarged and positioned to improve legibility. Further, the particular shapes of the elements as drawn are not intended to convey any information regarding the actual shape of the particular elements and have been solely selected for ease of recognition in the figures. Furthermore, while the figures may show specific layouts, one skilled in the art will appreciate that variations in design, layout, and fabrication are possible and the shown layouts are not to be construed as limiting the geometry of the present systems, methods and apparatus.

### DETAILED DESCRIPTION OF THE INVENTION

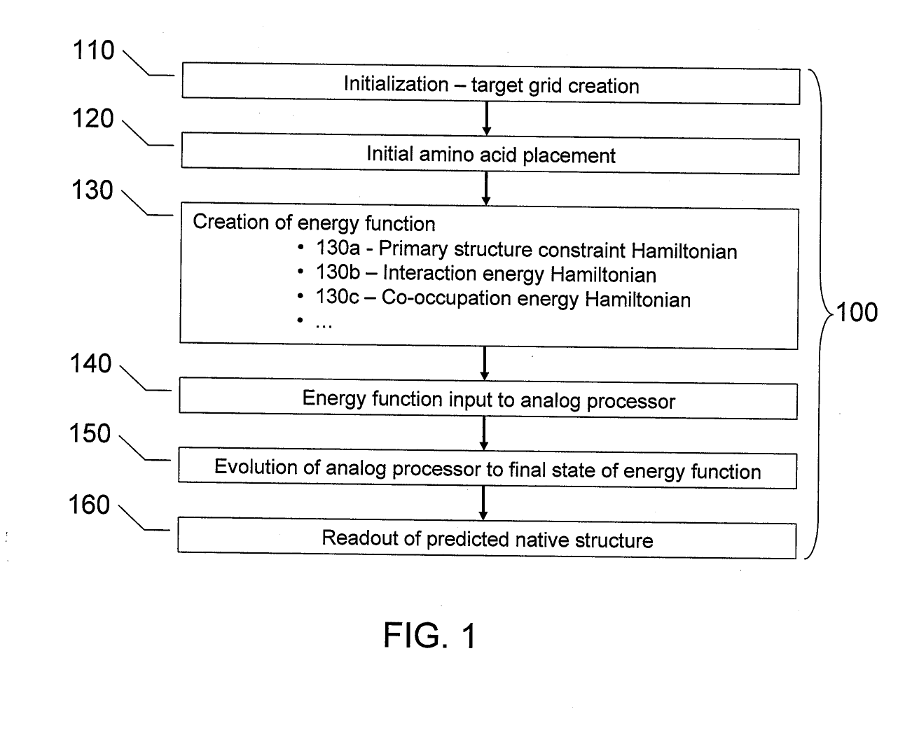

FIG. 1 illustrates a process 100 for predicting the native structure of a protein in accordance with an aspect of the present systems, methods and apparatus.

At 110, a target graph is created, of sufficient size and configuration to store any possible fold of the protein for which the native structure is to be determined. For example, the target graph may be a two-dimensional lattice or it may be a cubic lattice. Other target graphs, such as lattices having dimensions greater than 3, may be desirable, depending on the protein to be folded and other constraints of the simulation. Furthermore, the target graph may have a coordinate system that is independent from the protein (such as a grid with grid points (vertices) at intervals (e.g., regular intervals) that do not depend on the structure of the protein) or a coordinate system that inherits its structure from the protein itself, with the graph having grid points (vertices) only in positions that are allowed or necessary for modeling the structure of the protein.

At 120, a first amino acid in the chain is selected and placed in the target graph. The amino acid may be any one of the amino acids in the chain, however, in certain cases it may be beneficial to select the first amino acid in the chain, the last amino acid in the chain, or an amino acid at or near the midpoint of the chain. Similarly, while the selected amino acid may be placed at any location in the target graph, in some cases the amino acid may be placed at a central location in the target graph, or alternatively, at a location on the periphery of the target graph. Based on the placement of the first amino acid, there inherently exist a plurality of possible locations in the target graph for each remaining amino acid and accordingly, a plurality of possible configurations of the protein. However, using the present methods, systems and apparatus, it is not necessary to determine each possible location/configuration.

At 130, the energy function for the predicted native structure is determined through an evaluation of a series of Hamiltonians, such as a primary structure constraint Hamiltonian (130a), an interaction energy Hamiltonian (130b) and a co-occupation energy Hamiltonian (130c). Other terms may be added to the energy function if desired, such as other constraints or other interactions between amino acids. For example, a Hamiltonian may be developed based on permissible spatial conformations of subsets of amino acids in the protein (e.g., for a protein A-B-C-D-E, a Hamiltonian representing permissible configurations of each triplet of amino acids in the series, A-B-C, B-C-D and C-D-E could be included in the energy function).

At 140, the energy function (composite of the Hamiltonian terms) is compiled, translated into a form that is readable by an analog processor, such as a quantum processor, and is input to the analog processor.

At 150, a natural physical evolution of the analog processor is performed to evolve the analog processor to a final or ground state of the energy function, and at 160, the predicted native structure is read out, based on the final state of the analog processor.

### EXAMPLE 1

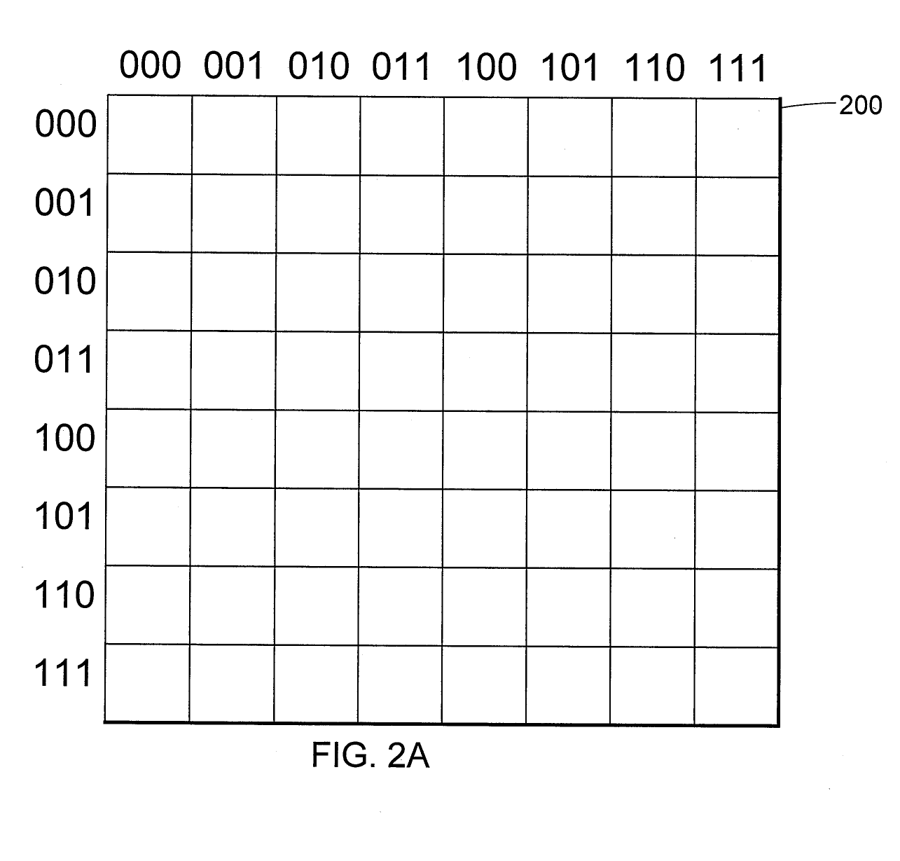

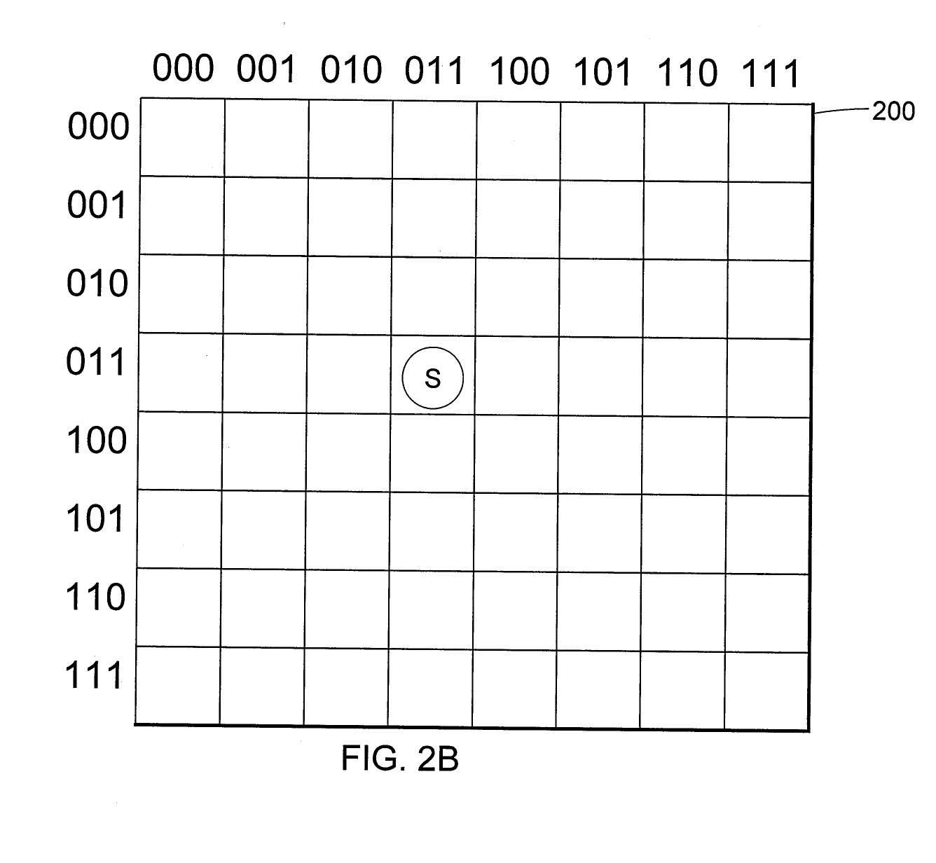

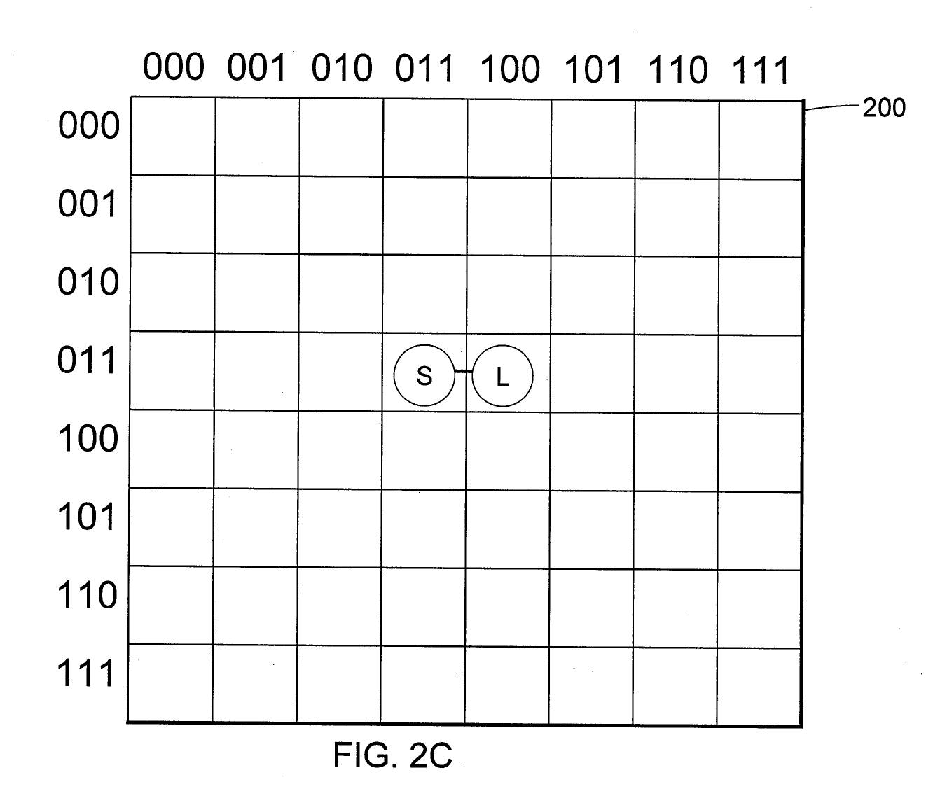

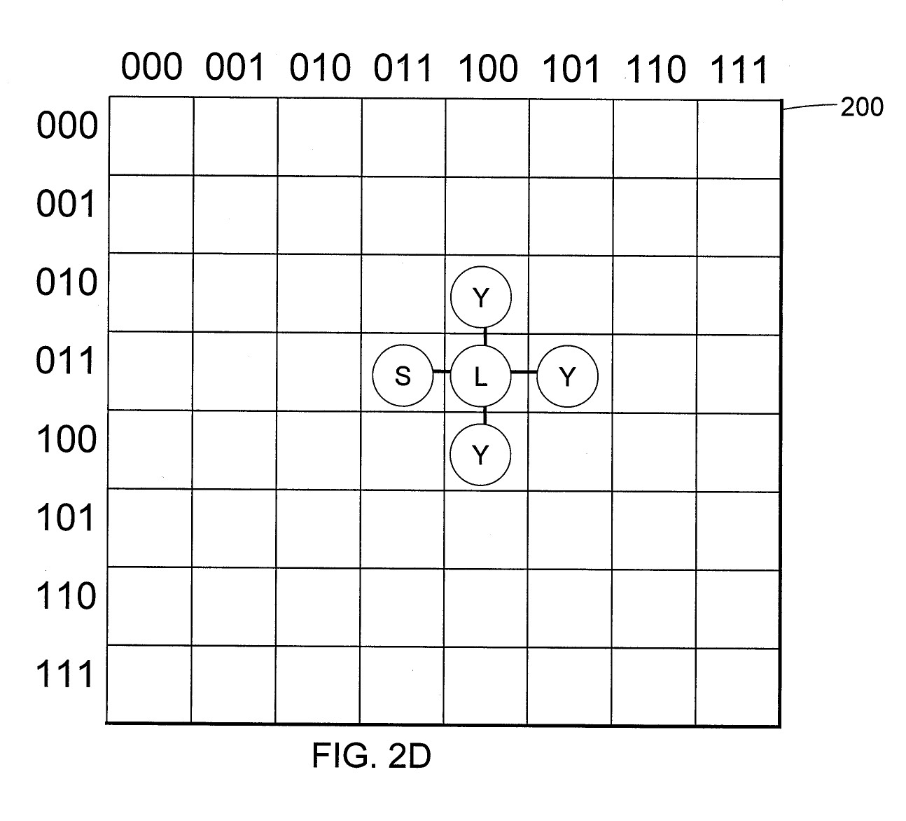

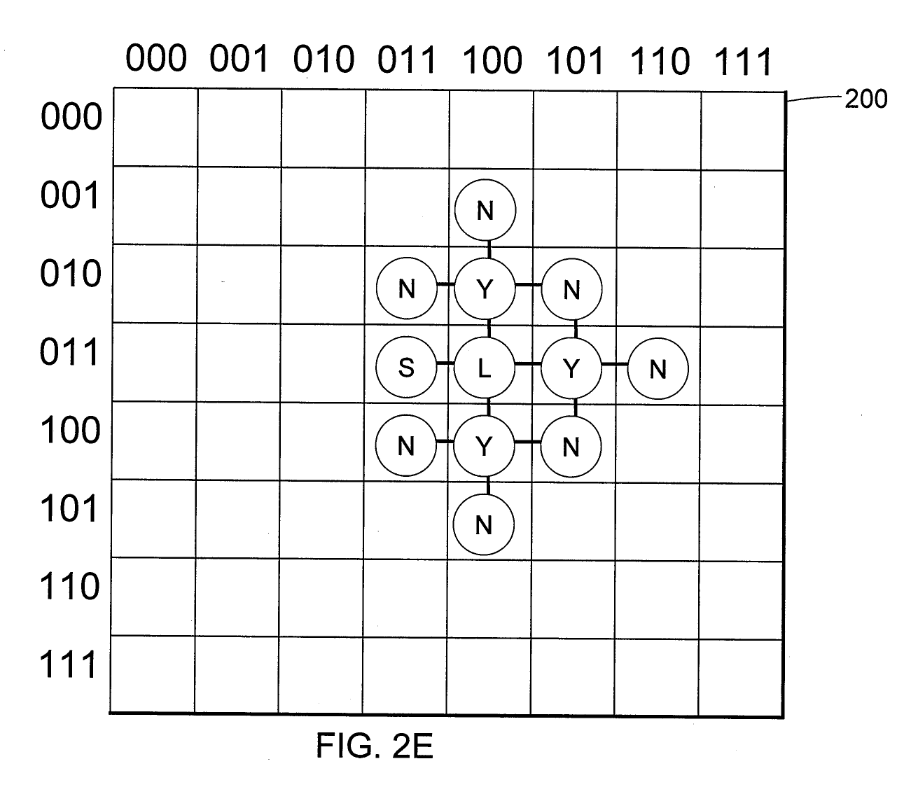

FIGS. 2A through 2E illustrate the simulation of the folding of a protein according to one embodiment of the present systems, methods and apparatus. In particular, FIGS. 2A through 2E depict the determination of the lowest energy spatial configuration of an arbitrary protein, having a primary structure composed of amino acids S, L, Y and N (primary structure=S-L-Y—N), on a two-dimensional lattice or grid. Those of skill in the art will appreciate that although a two-dimensional lattice has been used for ease of illustration, a lattice of any number of dimensions may be used. In particular, a cubic lattice may be useful for predicting the native structure of a protein having more than two amino acids.

Initialization (Act 110 of FIG. 1)

The number of amino acids in the subject protein is n=4, therefore, a target graph is created, in this case, a two-dimensional square lattice 200 of side length G=8, as shown in FIG. 2A. Since in this example the protein will be embedded by assigning amino acids sequentially starting at one end, having a side length of at least twice the number of amino acids in the protein (in this case 4×2=8) ensures that the protein can be embedded in the target graph. While generally discussed in terms of assigning amino acids to locations, the assignment can as well be described as assigning a location in the target grid to represent a respective amino acid. Such descriptions are used interchangeably herein. G can be set equal to the smallest integer power of 2 large enough to fit the protein. Those of skill in the art will appreciate that smaller or larger lattices of different configuration (e.g., rectangular) may be employed where assignment begins with an amino acid at a different location in the chain, and that coordinate systems other than Cartesian, such as spherical coordinates, may be used. Each of the vertical and horizontal axes are labeled in binary, and since lattice 200 is of dimension D=2, the number of binary digits required to uniquely identify each row or column in the lattice is log₂G, or in this case 3, so the number of binary digits to identify a grid point is 6 (3 for the column and 3 for the row).

The distance squared (d_{AB}²) between two grid points A and B, having bit strings [a₆a₅a₄,a₃a₂a₁] and [b₆b₅b₄,b₃b₂b₁] respectively, is:

$${d}_{AB}^{2} = {\sum }_{d = 1}^{D} {[ {\sum }_{j = 1 + ( d - 1 ) {log}_{2} G}^{d {log}_{2} G} {2}^{j - 1 - ( d - 1 ) {log}_{2} G} ( {a}_{j} - {b}_{j} ) ]}^{2} ,$$

where D is the total number of dimensions in the hypercube, d identifies an individual dimension, and j identifies the individual component of the bit string.
Initial Amino Acid Placement (Act 120 of FIG. 1)

The first amino acid in the primary structure, S, is assigned to a central location in the target graph, in this case, the grid point associated with the bit string [011, 011], as shown in FIG. 2B. In other words, the central location is assigned to represent the first amino acid. However, those of skill in the art will appreciate that the first amino acid may be placed at any location within the target graph, and that for certain proteins, other locations may be desirable, such as a corner of the target graph or at the center of an edge of the target graph.

Next, the plurality of possible locations for the remaining amino acids in the chain in grid 200 may be determined. Such a determination is unnecessary for the present methods, systems and apparatus, and, as the size of the protein increases, such a determination may consume processor time. However, for the purposes of illustration, the plurality of possible locations will be determined for the example protein. Thus, the next amino acid in the primary structure sequence is L, and it must be assigned to a grid point adjacent to S. In other words a grid point adjacent to S is assigned to represent the amino acid L.

Since a lattice model for the protein folding is being used, a constraint is set such that the primary structure constraint Hamiltonian will be minimized when amino acids adjacent in the primary structure are assigned adjacent grid points in the target graph. That is, for each pair of amino acids (A and B) placed in the target graph, d_{AB} (or d_{AB}²) must be equal to 1. However, those of skill in the art will appreciate that other constraints may be set, which will affect the placement of the amino acids in the target graph.

Because of the constraint requiring the placement of adjacent amino acids in adjacent grid points, the second amino acid from the primary sequence, L, must be placed in an adjacent grid point to S, that is d_{SL}²=1. In this case, as shown in FIG. 2C, L is arbitrarily assigned to a grid point with bit string [100, 011], however, analogous possible configurations would be created with L placed into a grid point associated with a bit strings [010, 011], [011, 010] or [011, 100]. Since each of the spatial orientations arising from the placement of L into any bit string [010, 011], [011, 010] or [011, 100] will result in symmetrical spatial orientations akin to L being placed into [100, 011], for simplicity, in this example the placement of the first two amino acids, S and L, are fixed at [011, 011] and [100, 011], respectively.

With S assigned to grid point [011, 011], L assigned to grid point [100, 011] and the requirement d_{YN}²=1, Y may occupy grid points [100, 010], [100, 100] or [101, 011], as shown in FIG. 2D. (In this example, no two amino acids may occupy the same grid point, as will be explained in further detail below, therefore Y may not occupy grid point [011, 011] since that is already occupied by S.)

Next, the final amino acid in the sequence, N, is assigned. The separation distance squared formula between amino acids Y and N is:

$${d}_{YN}^{2} = {[ {\sum }_{j = 1}^{3} {2}^{j - 1} ( {y}_{j} - {n}_{j} ) ]}^{2} + {[ {\sum }_{j = 4}^{6} {2}^{j - 4} ( {y}_{j} - {n}_{j} ) ]}^{2} ,$$

Thus, as shown in FIG. 2E:
for Y assigned to [100, 010], d_{YN}²=1 is satisfied for N assigned to the grid points having bit strings [011, 010], [100, 001] and [101, 010];
for Y assigned to [100, 100], d_{YN}²=1 is satisfied for N assigned to the grid points having bit strings [011, 100], [100, 101] and [101, 100]; and
for Y assigned to [101, 011], d_{YN}²=1 is satisfied for N assigned to the grid points having bit strings [101, 010], [101, 100] and [110, 011].

Similarly, a separation distance squared formula for amino acids L and Y could be written.

Having reached the end of the primary structure, all amino acids have been assigned possible grid points, or grid points have been assigned to represent all amino acids.

Creation of Energy Function (Act 130 of FIG. 1 )

Once at least one amino acid has been assigned a location, or possible location, in the grid 200, an energy function is created, which will be minimized to determine the lowest energy configuration of the protein, as a predictor of the native structure. This energy function is created based on the constraints and interactions to be included as part of the model, such as a preferred distance between amino acids, interactions between amino acids and a constraint that no two amino acids occupy the same point in space. Those of skill in the art will appreciate that many other constraints and interactions may be included as part of the energy function.

Determination of Primary Structure Constraint Hamiltonian

Since it is not yet known which grid points are contained within the lowest energy spatial configuration for the protein S-L-Y—N, the primary structure constraint Hamiltonian corresponding to the grid points of Y and N must therefore exhibit a minimum for all allowable spatial configurations as dictated by the primary structure. One way of achieving this is through the creation of a primary structure constraint Hamiltonian, such that any spatial configuration in which the distance between amino acids that are adjacent in the primary structure is greater than one grid point exhibits an increase in energy, thereby making these configurations unfavorable.

For example, for two amino acids (A and B), a primary structure constraint Hamiltonian may be written as:
H_{AB}=E_{AB}(1−d_{AB}²)²,
where E_{AB} is a primary structure penalty energy. Thus, where d_{AB}²=1, the primary structure constraint Hamiltonian is zero, while for any other distance it has a positive value. The most favorable structure of the protein, considering only relative distance of the constituent amino acids, will be the structure having the minimum value of H_{AB}.

Returning to the example protein S-L-Y—N, the complete primary structure constraint Hamiltonian is:
H_{Primary}=H_{SL}+H_{LY}+H_{YN}.

Since the positions of the first two amino acids, S and L, were arbitrarily fixed, H_{SL} will be the same for all configurations, and the structure of the protein having the minimum H_{Primary} can found without calculating H_{SL}. The primary structure constraint Hamiltonian becomes:
H_{Primary}=H_{LY}+H_{YN}.

H_{Primary} is responsible for maintaining the order of the primary structure of amino acids. To fully analyze the shape the primary structure takes, interactions between amino acids that are non-adjacent in the primary structure must also be considered.

Determination of Interaction Energy Hamiltonian

The spatial configuration of the protein S-L-Y—N will favor certain geometries due to interactions between amino acids, such as hydrogen bonding, hydrophobic interactions, Van der Waals interactions, ionic interactions and disulphide bonding. In particular, pairs of amino acids that are non-adjacent in the primary structure will interact. For example, pairs of amino acids will either be attracted together or repelled by one another. This interaction energy Hamiltonian term may be written:

$${H}_{int} = {\sum }_{A = 1}^{n - 2} {\sum }_{B = A + 2}^{n} {E}_{Int}^{AB} exp [ - {Λ}_{AB} {d}_{AB}^{2} ] ,$$

where E_{Int}^{AB} is an interaction energy associated with the interaction between the A^{th} and B^{th} amino acids, and A_{AB} is a cutoff term associated with the interaction between the A^{th} and B^{th} amino acids. The primary sum (i.e., the sum from A=1 to n−2) must be completed over all amino acids excluding the last two, and the secondary sum (i.e., the sum from B=A+2 to n) must be completed over all amino acids located two or more positions away from the A^{th} amino acid. Those with skill in the art will recognize that other pairwise interaction terms may also be used.

Returning to the example protein S-L-Y—N, the interaction energy Hamiltonian will depend upon both E_{Int}^{AB} and Λ_{AB} regarding each pair of A^{th} and B^{th} amino acid interactions.

Determination of Co-Occupation Energy Hamiltonian

In most cases, a constraint will be applied such that no two amino acids may co-occupy a single grid point (i.e., no two amino acids may have identical bit strings). To enforce this constraint, a Hamiltonian term may be created for all pairs of amino acids that are non-adjacent in the primary structure, so as to prohibit spatial configurations having two amino acids co-occupying a single grid point. The term may be written:

$${H}_{Occupy} = {E}_{Occupy} {\sum }_{A = 1}^{n - 2} [ {\sum }_{B = A + 2}^{n} ( {\sum }_{j = 1}^{D {log}_{2} G} {( {a}_{j} + {b}_{j} - 1 )}^{2} ) ] ,$$

where E_{Occupy} is a co-occupation penalty energy, a represents the bit string components of the A^{th} amino acid in the primary structure, b represents the bit string components of the B^{th} amino acid in the primary structure, and j identifies the individual component of the bit string. In every case where the bit strings of the A^{th} and B^{th} amino acids differ, the co-occupation Energy Hamiltonian associated with the A^{th} and B^{th} amino acids will evaluate to zero, otherwise, a co-occupation penalty energy will be associated with the spatial configuration.

Thus, for the protein S-L-Y—N, where Y is placed in any of [011, 010], [100, 001] or [101, 010], the H_{Occupy} term for A=1 (corresponding to S) and B=3 (corresponding to L) evaluates to 0. As each of the three possible locations in the target graph for Y listed differ from the location of S [011, 011] in the target graph, when

$${\prod }_{j = 1}^{6} {( {s}_{j} + {y}_{j} - 1 )}^{2}$$

is calculated, it evaluates to 0.

However, if Y is placed in the same grid point as S (a configuration permitted by the primary structure constraint Hamiltonian), the H_{Occupy} term for A=1 (corresponding to S) and B=3 (corresponding to L) evaluates to 1, rendering the spatial configuration having Y in the same grid point as S less energetically favorable than all other spatial configurations permitted by the primary structure constraint Hamiltonian. Similarly, spatial configurations in which N occupies a grid point already assigned to L at [011, 100] will be less energetically favorable than all other spatial configurations permitted by the primary structure constraint Hamiltonian. H_{Occupy} corresponding to spatial configurations permitted by the co-occupation energy Hamiltonian will exhibit minimums and will therefore be energetically favorable as compared to spatial configurations not permitted by the co-occupation energy Hamiltonian.

Compiling the Hamiltonian

The overall Hamiltonian for the S-L-Y—N amino acid is a sum of all of the constituent Hamiltonian components. Where only the primary structure constraint Hamiltonian, the interaction energy Hamiltonian and the co-occupation energy Hamiltonian energy are considered, the overall Hamiltonian is written:
H=H_{Primary}+H_{Int}+H_{Occupy}.
Energy Function Input to Analog Processor (Act 140 of FIG. 1)

Since the overall Hamiltonian is dependent only on distances between pairs of amino acids, and known relationships exist between these distances and the programming language of the analog processor, this energy function is translatable to a form that is solvable by the analog processor. Thus, the energy function is processed into a form suitable for the analog processor, and then supplied to it as an input.

Solving the Problem (Acts 150 and 160 of FIG. 1)

In order to solve the problem, a natural physical evolution of the analog processor is performed to transition the analog processor from an initial state to a final state which represents the energy function corresponding to a spatial configuration of the primary structure. The final state may be a ground state representing a minimization of the energy function. That is, following evolution, reading out the state of the analog processor will return a set of bit strings which represent the positions of all amino acids in the primary structure in the minimum energy spatial configuration, representing the predicted native structure of the protein.

### EXAMPLE 2

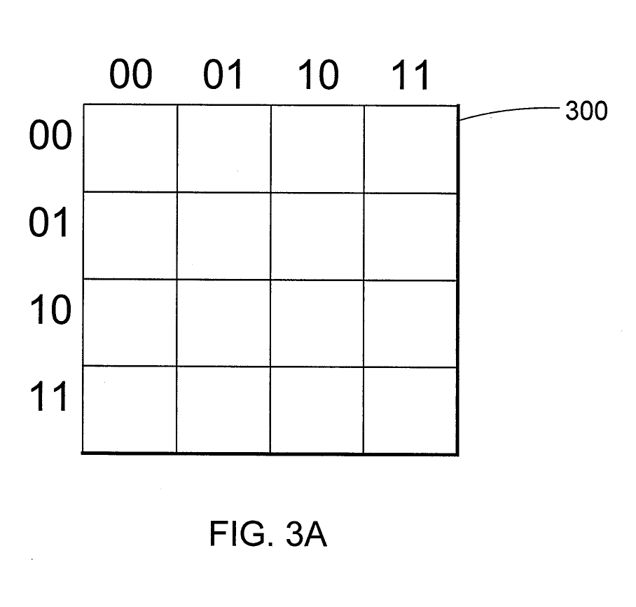

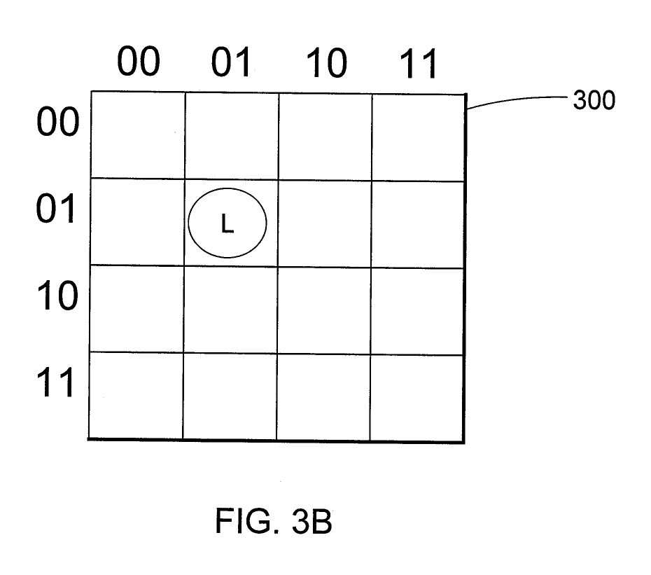

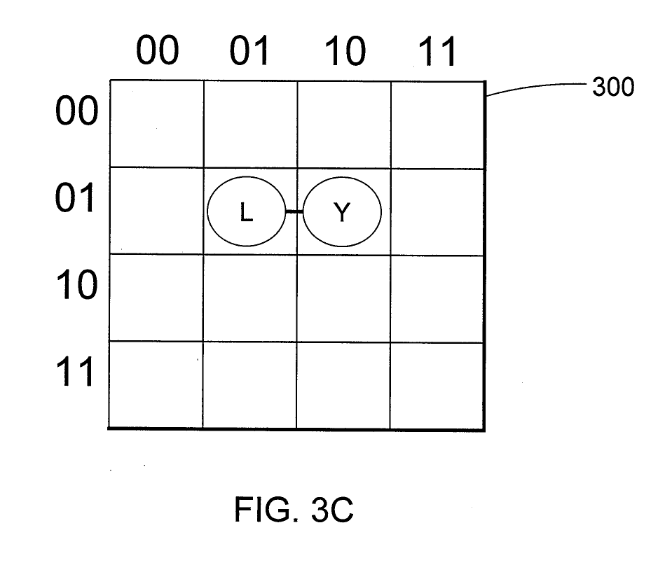

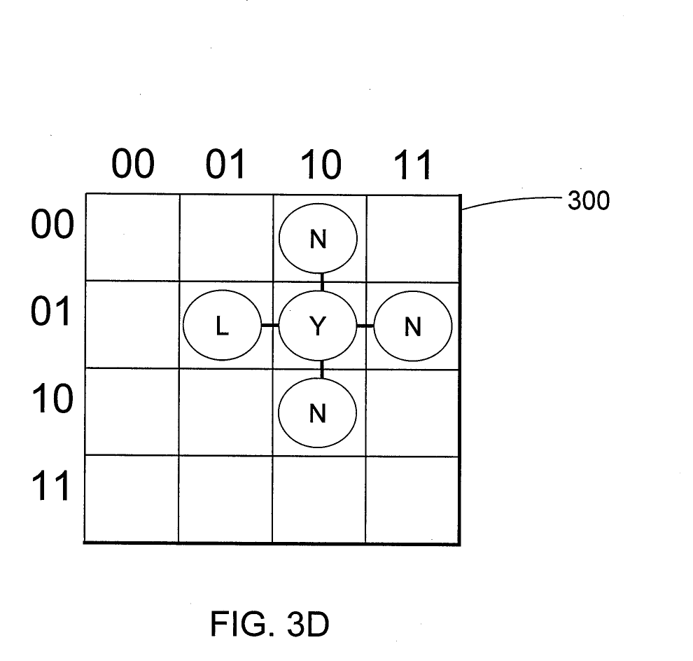

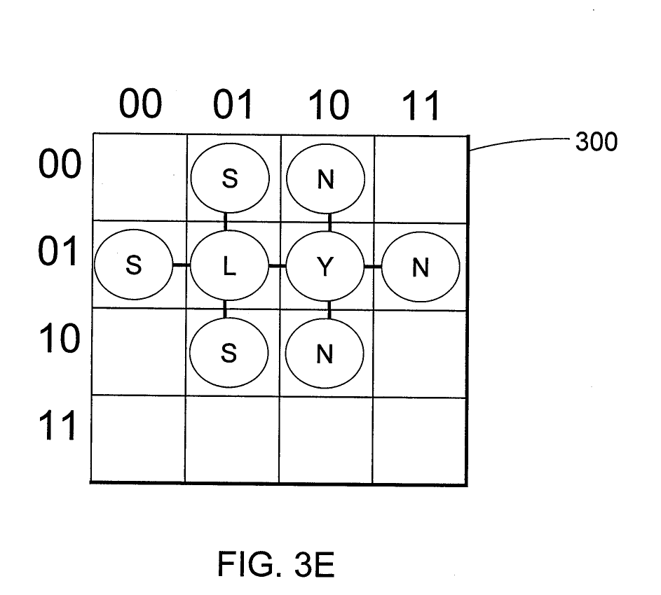

FIGS. 3A through 3E illustrate another embodiment of the present systems, methods and apparatus, in which the lowest-energy spatial configuration of the protein of Example 1 (S-L-Y—N) is placed on a smaller target graph. In some cases, a smaller target graph may be desirable, and may allow the use of an analog processor having fewer devices.

In this example, the target graph 300 that is created is a two-dimensional square lattice of side length G=4, as shown in FIG. 3A. Target graph 300 is smaller than target graph 200 of FIG. 2A since, as will be discussed below, the amino acid selected as the first amino acid to be placed is adjacent to the midpoint of the protein and the amino acid will be placed in the central area of target graph 300. Thus, any possible native structure of the protein can be placed in a square grid having a side length equal to the number of amino acids in the protein.

Each of the vertical and horizontal axes of target graph 300 are labeled in binary, and since the target graph is of dimension D=2, the number of binary digits required to uniquely identify each row or column in the grid is log₂G, or in this case 2, so the number of binary digits to identify each grid point is 4 (2 for the column and 2 for the row).

In this example, the central amino acid in the primary structure, L, is assigned to a central location in the target graph, in this case, the grid point associated with the bit string [01, 01], as shown in FIG. 3B.

A constraint requiring the placement of adjacent amino acids in adjacent grid points is again applied in this example. This calls for the next amino acid in the primary structure, Y, be placed in an adjacent grid point to L (i.e., d_{LY}²=1). In this case, as shown in FIG. 3C, Y is arbitrarily assigned to a grid point with bit string [10, 01]. Analogous possible configurations with Y placed into a grid point associated with a bit string [01, 10], however, since the spatial orientations arising from the placement of L into bit string [01, 10] result in a symmetrical spatial orientations akin to L being placed into [10, 01], for simplicity, in this example the placement of the central and next amino acids, L and Y, is fixed at [01, 01] and [10, 01], respectively.

In this case, only one amino acid, N, follows Y. A separation distance squared formula between amino acids Y and N is written:

$${d}_{YN}^{2} = {[ {\sum }_{j = 1}^{2} {2}^{j - 1} ( {y}_{j} - {n}_{j} ) ]}^{2} + {[ {\sum }_{j = 3}^{4} {2}^{j - 3} ( {y}_{j} - {n}_{j} ) ]}^{2} ,$$

thus, as shown in FIG. 3D, for Y assigned to [10, 01], d_{YN}²=1 is satisfied for N assigned to grid points having bit strings [10, 00], [10, 10] and [11, 01]. Because of the constraint forbidding placement of two amino acids in the same grid point, N may not occupy grid point [01, 01].

Similarly, only one amino acid, S, precedes the central amino acid L in the primary structure, and it must be assigned to a grid point adjacent to L. With L assigned to grid point [01, 01], Y assigned to grid point [10, 01] and the requirement d²_{SL}=1, S may occupy grid points [00, 01], [01, 00] or [01, 10], as shown in FIG. 3E. Because of the constraint forbidding placement of two amino acids in the same grid point, S may not occupy grid point [10, 01].

Since all amino acids in the primary structure have now been assigned, the process now continues to the creation of the energy function, provision of the energy function to the analog processor, minimization of the energy function via evolution of the analog processor, and determination of a predicted native structure based on the final state of the analog processor.

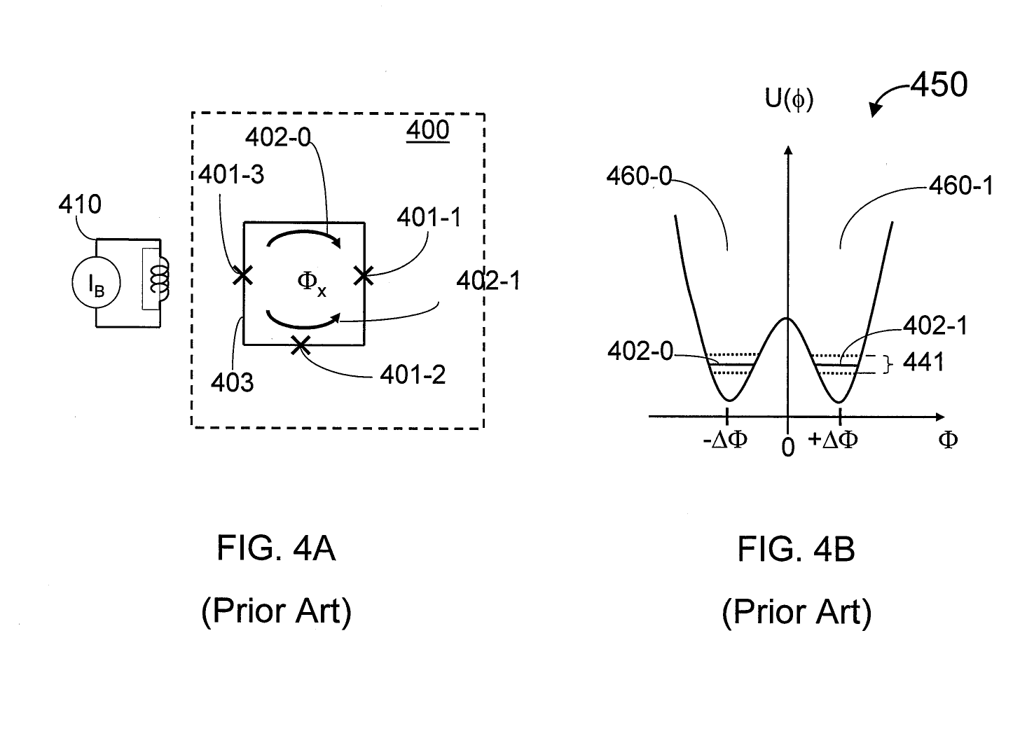

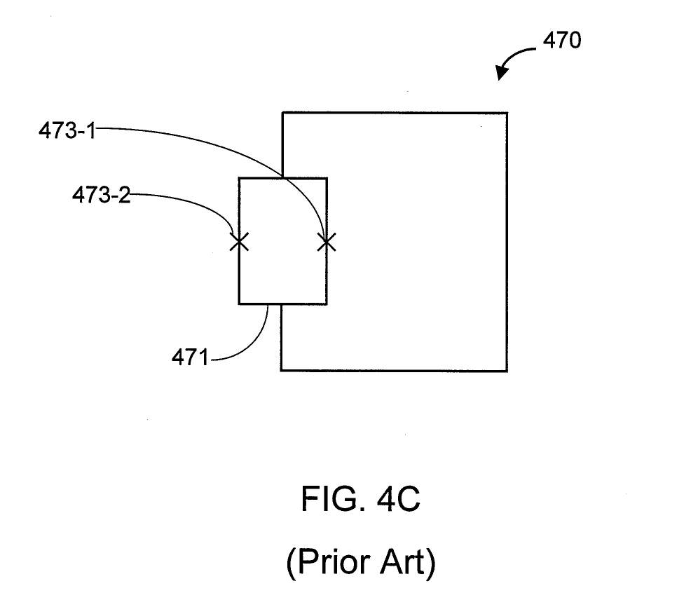

FIG. 4A shows a quantum device 400 suitable for use in some embodiments of the present methods, systems and apparatus. Quantum device 400 includes a superconducting loop 403 interrupted by three Josephson junctions 401-1, 401-2 and 401-3. Current can flow around loop 403 in either a clockwise direction (402-0) or a counterclockwise direction (402-1), and in some embodiments, the direction of current may represent the state of quantum device 400. Unlike classical devices, current can flow in both directions of superconducting loop 403 at the same time, thus enabling the superposition property of qubits. Bias device 410 is located in proximity to quantum device 400 and inductively biases the magnetic flux through loop 403 of quantum device 400. By changing the flux through loop 403, the characteristics of quantum device 400 can be tuned.

Quantum device 400 may have fewer or more than three Josephson junctions. For example, quantum device 400 may have only a single Josephson junction, a device that is commonly known as an rf-SQUID (i.e., “superconducting quantum interference device”). Alternatively, quantum device 400 may have two Josephson junctions, a device commonly known as a dc-SQUID. See, for example, Kleiner et al., 2004, Proc. of the IEEE 92, pp. 1534-1548; and Gallop et al., 1976, Journal of Physics E: Scientific Instruments 9, pp. 417-429.

Fabrication of quantum device 400 and other embodiments of the present systems, methods and apparatus are well known in the art. For example, many of the processes for fabricating superconducting circuits are the same as or similar to those established for semiconductor-based circuits. Niobium (Nb) and aluminum (Al) are superconducting materials common to superconducting circuits, however, there are many other superconducting materials any of which can be used to construct the superconducting aspects of quantum device 400. Josephson junctions that include insulating gaps interrupting loop 403 can be formed using insulating materials such as aluminum oxide or silicon oxide to form the gaps.

The potential energy landscape 450 of quantum device 400 is shown in FIG. 4B. Energy landscape 450 includes two potential wells 460-0 and 460-1 separated by a tunneling barrier. The wells correspond to the directions of current flowing in quantum device 400. Current direction 402-0 corresponds to well 460-0 while current direction 402-1 corresponds to well 460-1 in FIGS. 4A and 4B. However, this choice is arbitrary. By tuning the magnetic flux through loop 403, the relative depth of the potential wells can be changed. Thus, with appropriate tuning, one well can be made much shallower than the other. This may be advantageous for initialization and measurement of the qubit.

While quantum device 400 shown in FIGS. 4A and 4B is a superconducting qubit, quantum device may be any other technology that supports quantum information processing and quantum computing, such as electrons on liquid helium, nuclear magnetic resonance qubits, quantum dots, donor atoms (spin or charges) in semiconducting substrates, linear and non-linear optical systems, cavity quantum electrodynamics, and ion and neutral atom traps.

Where quantum device 400 is a superconducting qubit as shown in FIGS. 4A and 4B, the physical characteristics of quantum device 400 include capacitance (C), inductance (L), and critical current (I_{C}), which are often converted into two values, the Josephson energy (E_{J}) and charging energy (E_{C}), and a dimensionless inductance (β_{L}). Those of skill in the art will appreciate that the relative values of these quantities will vary depending on the configuration of quantum device 400. For example, where quantum device 400 is a superconducting flux qubit or a flux qubit, the thermal energy (k_{B}T) of the qubit may be less than the Josephson energy of the qubit, the Josephson energy of the qubit may be greater than the charging energy of the qubit, or the Josephson energy of the qubit may be greater than the superconducting material energy gap of the materials of which the qubit is composed. Alternatively, where quantum device 400 is a superconducting charge qubit or a charge qubit, the thermal energy of the qubit may be less than the charging energy of the qubit, the charging energy of the qubit may be greater than the Josephson energy of the qubit, or the charging energy of the qubit may be greater than the superconducting material energy gap of the materials of which the qubit is composed. In still another alternative, where the quantum device is a hybrid qubit, the charging energy of the qubit may be about equal to the Josephson energy of the qubit. See, for example, U.S. Pat. No. 6,838,694 and U.S. Patent Publication No. 2005-0082519, each of which is hereby incorporated by reference in its entirety.

The charging and Josephson energies, as well as other characteristics of a Josephson junction, can be defined mathematically. The charging energy of a Josephson junction is (2e)²/2C where e is the elementary charge and C is the capacitance of the Josephson junction. The Josephson energy of a Josephson junction is ( [symbol] /2e)O_{C}. If the qubit has a split or compound junction, the energy of the Josephson junction can be controlled by an external magnetic field that threads the compound junction. A compound junction includes two Josephson junctions in a small superconducting loop. For example, FIG. 4C illustrates a device 470 in which a compound junction having two Josephson junctions 473-1, 473-2 (collectively 473) are found in a small superconducting loop 471. The Josephson energy of the compound junction can be tuned from about zero to twice the Josephson energy of the constituent Josephson junctions 473. In mathematical terms,

$${E}_{J} = 2 {E}_{J}^{0} \vert cos ( \frac{π {Φ}_{X}}{{Φ}_{0}} ) \vert$$

where Φ_{X} is the external flux applied to the compound Josephson junction, and E_{J}⁰ is the Josephson energy of one of the Josephson junctions in the compound junction. The dimensionless inductance βof a qubit is 2πLI_{C}/Φ₀, where Φ₀ is the flux quantum. In some cases, β may range from about 1.2 to about 1.8, while in other cases, β is tuned by varying the flux applied to a compound Josephson junction.

Again, those of skill in the art will appreciate that a wide variation of type of quantum device 400 may be employed in the present systems, methods and apparatus. For example, a qutrit may be used (i.e., a quantum three level system, having one more level compared to the quantum two level system of the qubit). Alternatively, the quantum device 400 may have or employ energy levels in excess of three. The quantum devices described herein can be modified with known technology. For instance, quantum device 400 may include a superconducting qubit in a gradiometric configuration, since gradiometric qubits are less sensitive to fluctuations of magnetic field that are homogenous across the qubit.

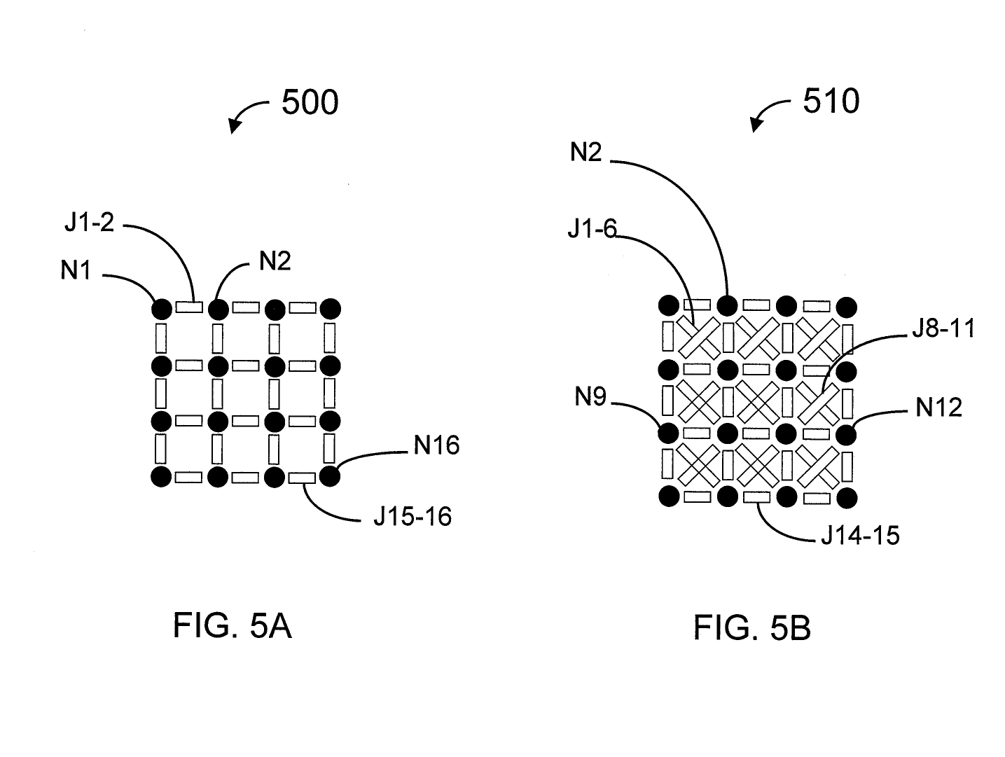

FIGS. 5A and 5B illustrate sets of interconnected topologies of quantum devices in accordance with aspects of the present systems, methods and apparatus. FIG. 5A shows a two-dimensional grid 500 of quantum devices N1 through N16 (only N1, N2 and N16 are labeled), each quantum device Nk being coupled together to its nearest neighbors via coupling devices Ji-k (only J1-2 and J15-16 are labeled). Quantum devices N may include, for example, the three junction qubit 400 of FIG. 4A, rf-SQUIDs, and dc-SQUIDs, while coupling devices J may include, for example, rf-SQUIDs and dc-SQUIDs. Those of skill in the art will appreciate that grid 500 may include any number of quantum devices Nk.

Coupling devices Ji-k may be tunable, meaning that the strength of the coupling between two quantum devices created by the coupling device can be adjusted. For example, the strength of the coupling may be adjustable (tunable) between about zero and a preset value, or the sign of the coupling may be changeable between ferromagnetic and anti-ferromagnetic. (Ferromagnetic coupling between two quantum devices means it is energetically more favorable for both of them to hold the same basis state (e.g., same direction of current flow), while anti-ferromagnetic coupling means it is energetically more favorable for the two devices to hold opposite basis states (e.g., opposing directions of current flow)). Where grid 500 includes both types of couplings, it may be used to simulate an Ising system, which can be useful for quantum computing, such as thermally-assisted adiabatic quantum computing. Examples of coupling devices include, but are not limited to, variable electrostatic transformers and rf-SQUIDs with β_{L}<1. See, for example, U.S. Patent Application Ser. No. 11/100,931 entitled “Variable Electrostatic Transformer,” and U.S. Patent Application Publication No. 2006-0147154, each of which is hereby incorporated be reference in its entirety.

FIG. 5B illustrates a two-dimensional grid 510 of quantum devices N coupled by coupling devices J. In contrast to FIG. 5A, each quantum device N is coupled to both its nearest neighbors and its next-nearest neighbors. The next-nearest neighbor coupling is shown as diagonal blocks, such as couplings J1-6 and J8-11. The next nearest neighbor coupling shown in grid 510 may be beneficial for mapping certain problems onto grid 510. For example, some optimization problems that can be embedded on a planar grid can be embedded using fewer quantum devices when next-nearest neighbor coupling is available. Those of skill in the art will appreciate that grid 510 may be expanded or contracted to include any number of quantum devices. In addition, the connectivity between some or all of the quantum devices in grid 510 may be greater or lesser than that shown.

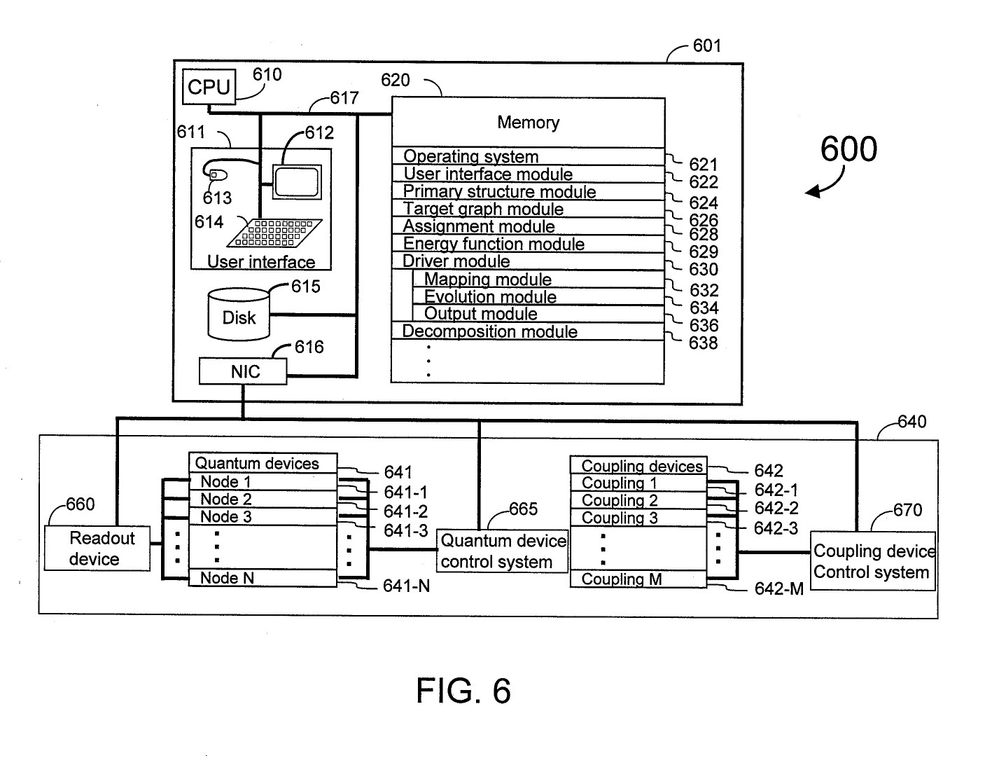

Determination of natural structure configurations may be done through a combination of classical and analog computing devices, such as, for example, where a classical computing device handles the placement of amino acids and creation of the Hamiltonian, and a quantum computing device handles the computation of the final state of the Hamiltonian. FIG. 6 illustrates a system 600 that may be operated in accordance with one embodiment of the present systems, methods and apparatus. System 600 includes digital (binary, conventional, classical, etc.) interface computer 601 configured to receive an input, such as the primary structure.

Computer 601 includes standard computer components including a central processing unit 610, data storage media for storing program modules and data structures, such as high speed random access memory 620 as well as non-volatile memory, such as disk storage 615, user input/output subsystem 611, a network interface card (NIC) 616 and one or more busses 617 that interconnect some or all of the aforementioned components. User input/output subsystem 611 includes one or more user input/output components such as a display 612, mouse 613 and/or keyboard 614.

System 600 further includes a processor 640, such as a quantum processor having a plurality of quantum devices 641 and a plurality of coupling devices 642, such as, for example, those described above in relation to FIGS. 5A and 5B. Processor 640 is interchangeably referred to herein as a quantum processor, analog processor or processor.

System 600 further includes a readout device 660. In some embodiments, readout device 660 may include a plurality of dc-SQUID magnetometers, each inductively connected to a different quantum device 641. In such cases, NIC 616 may receive a voltage or current from readout device 660, as measured by each dc-SQUID magnetometer in readout device 660. Processor 640 further comprises a controller 670 that includes a coupling control system for each coupling device 642, each coupling control system in control device 670 being capable of tuning the coupling strength of its corresponding coupling device 642 through a range of values, such as between −|J_{c}| to +|J_{c}|, where |J_{c}| is a maximum coupling value. Processor 640 further includes a quantum device control system 665 that includes a control device capable of tuning characteristics (e.g., values of local bias hᵢ) of a corresponding quantum device 641.

Memory 620 may include an operating system 621. Operating system 621 includes procedures for handling various system services, such as file services, and for performing hardware-dependent tasks. The programs and data stored in system memory 620 may further include a user interface module 622 for defining or for executing a problem to be solved on processor 640. For example, user interface module 622 may allow a user to define a problem to be solved by setting the values of couplings Jᵢⱼ and the local bias hᵢ, adjusting run-time control parameters (such as evolution schedule), scheduling the computation, and acquiring the solution to the problem as an output. User interface module 622 may include a graphical user interface (GUI) or it may simply receive a series of command line instructions that define a problem to be solved.

Memory 620 may further include a primary structure module 624 for determining the primary structure of a protein, wherein the primary structure is composed of an ordered series of amino acids. A database of primary structures may be stored in the disk 615. The primary structure could be given to the computer through another computer coupled to computer 601 by a network, for example a local area network (LAN), wide area network (WAN) such as the Internet, other forms of networks, and/or other forms of electronic communication (e.g., ethernet, parallel cable, or serial connection).

Memory 620 may include a target graph creation module 626 for creating the target graph of sufficient size onto which to map the primary structure. For example, an 8×8 target graph may be created (FIG. 2A) or a 4×4 target graph may be created (FIG. 3A) in accordance with act 110. The target graph may be a hypercube of any dimension that would most efficiently predict a native structure of the primary structure being examined.

Memory 620 may further include an assignment module 628 for the initial assignment of the first amino acid into the target graph. In some embodiments, additional amino acid placements may be completed by the assignment module. Based on the placement of the first amino acid alone, there inherently exist a plurality of possible locations in the target graph for each remaining amino acid and accordingly, a plurality of possible configurations of the protein.

Memory 620 may further include an energy function module 629 for generating an energy function based on possible configurations of the protein in the target graph, in accordance with act 130. A primary structure constraint Hamiltonian may be created for all possible configurations of the primary structure in the target graph, in accordance with act 130a (FIG. 1). An interaction Hamiltonian may be created for all possible configurations of the primary structure in the target graph, in accordance with act 130b (FIG. 1). A co-occupation Hamiltonian may be created for all possible configurations of the primary structure in the target graph, in accordance with act 130c (FIG. 1).

Memory 620 may further include a driver module 630 for outputting signals to processor 640. Driver module 630 may include a mapping module 632, evolution module 634 and output module 636. For example, mapping module 632 may determine the appropriate values of coupling Jᵢⱼ for the coupling devices 642 and values of local bias hᵢ for the quantum devices 641 of processor 640, for a given problem, as defined by the energy function module 629. In some cases, mapping module 632 may, in accordance to act 140 (FIG. 1), include instructions for converting aspects in the energy function Hamiltonian into values for the processor, such as coupling strength values and node bias values. Mapping module 632 then sends the appropriate signals along bus 617, into NIC 616 which, in turn, sends appropriate commands to quantum device control system 665 and controller 670.

Alternatively, evolution module 634 may determine the appropriate values of coupling Jᵢⱼ for coupling devices 642 and values of local bias hᵢ for quantum devices 641 of processor 640 in order to fulfill some predetermined evolution, in accordance to act 150 (FIG. 1). Evolution module 634 then sends the appropriate signals along bus 617, into NIC 616, which then sends commands to quantum device control system 665 and coupling device control system 670. Output module 636 is used for processing and providing the solution provided by processor 640, in accordance to act 160.

Memory 620 may further include a decomposition module 638 for decomposing large problems into smaller problems. A problem may be decomposed to create subproblems of a size which can be mapped onto the quantum devices 641 of processor 640.

NIC 616 may include hardware for interfacing with quantum devices 641 and coupling devices 642 of processor 640, either directly or through readout device 660, quantum device control system 665, and/or coupling device control system 670, or software and/or hardware that translates commands from driver module 630 into signals (e.g., voltages, currents) that are directly applied to quantum devices 641 and coupling devices 642. NIC 616 may include software and/or hardware that translates signals, representing a solution to a problem or some other form of feedback, from quantum devices 641 and coupling devices 642 such that it can be provided to output module 636.

While a number of modules and data structures resident in memory 620 of FIG. 6 have been described, it will be appreciated that at any given time during operation of system 600, only a portion of these modules and/or data structures may in fact be resident in memory 620. In other words, there is no requirement that all or a portion of the modules and/or data structures shown in FIG. 6 may be located in memory 620. In fact, at any given time, all or a portion of the modules and/or data structures described above in reference to memory 620 of FIG. 6 may, in fact, be stored elsewhere, such as in non-volatile storage 615, or in one or more external computers, not shown in FIG. 6, that are addressable by computer 601 across a network (e.g., LAN, WAN such as the Internet or other communications channel).

Furthermore, while the software instructions have been described above as a series of modules (621, 622, 624, 626, 628, 629, 630, 632, 634 and 636), it will be appreciated by those of skill in the art that the present systems, methods and apparatus are not limited to the aforementioned combination of software modules. The functions carried out by each of these modules described above may be located in any combination of software or firmware programs, including a single software or firmware program, or a plurality of software or firmware programs and there is no requirement that such programs be structured such that each of the aforementioned modules are present and exist as discrete portions of the one or more software or firmware programs. Such modules have been described simply as a way to best convey how one or more software or firmware programs, operating on computer 601, would interface with processor 640 in order to compute solutions to the various problems.

Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other problem-solving systems devices, and methods, not necessarily the exemplary problem-solving systems devices, and methods generally described above.

For instance, the foregoing detailed description has set forth various embodiments of the systems, devices, and/or methods via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs) or Field Programmable Gate Arrays (FPGAs).

However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers), as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links, for example those using TDM or IP based communication links (e.g., packet links).

The various embodiments described above can be combined to provide further embodiments.

All of the U.S. patents, U.S. patent application publications, U.S. patent applications, foreign patents, foreign patent applications and non-patent publications referred to in this specification including, but not limited to: U.S. Pat. No. 6,838,694, U.S. Patent Publication No. 2005-0082519, U.S. Patent Publication No. 2006-0147154 and U.S. patent application Ser. No. 11/100,931; are incorporated herein by reference, in their entirety and for all purposes. Aspects of the embodiments can be modified, if necessary, to employ systems, circuits, and concepts of the various patents, applications, and publications to provide yet further embodiments.

These and other changes can be made to the embodiments in light of the above-detailed description. In general, in the following claims, the terms used should not be construed to limit the invention to the specific embodiments disclosed in the specification and the claims, but should be construed to include all possible embodiments along with the full scope of equivalents to which such claims are entitled. Accordingly, the scope of the invention shall only be construed and defined by the scope of the appended claims.

We/I claim:

1. A method for predicting native structures of proteins, the method comprising:
determining a primary structure of a protein, the primary structure indicative of a linear ordered sequence of a number of amino acids forming the protein;
assigning at least one location in a target graph to represent a respective one of the amino acids forming the protein;
generating an energy function based at least in part on the at least one assigned location in the target graph;
mapping the energy function onto an analog processor;
evolving the analog processor from an initial state to a final state; and
predicting a native structure representing a multi-dimensional geometry of the protein based at least in part on the final state of the analog processor.

2. The method of claim 1 wherein assigning at least one location in a target graph to represent a respective one of the amino acids forming the protein includes assigning a first location in the target graph to represent an amino acid that occupies one position in the ordered sequence and assigning a second location in the target graph to represent an amino acid that occupies another position in the ordered sequence, adjacent to the one position.

3. The method of claim 2 wherein the amino acid that occupies the one position in the ordered sequence is selected from the group consisting of a first amino acid in the ordered sequence, a last amino acid in the ordered sequence and an amino acid at or near a midpoint of the ordered sequence.

4. The method of claim 2 wherein assigning a first location in the target graph to represent an amino acid that occupies one position in the ordered sequence includes assigning a location selected from the group consisting of a central location in the target graph, an edge of the target graph and a corner of the target graph.

5. The method of claim 1 wherein generating an energy function based at least in part on the at least one assigned location in the target graph includes generating an energy function including at least one of a primary structure constraint Hamiltonian term, an interaction energy Hamiltonian term, and a co-occupation energy Hamiltonian term.

6. The method of claim 5 wherein the primary structure constraint Hamiltonian term exhibits a minimum value when the locations in the target graph assigned to represent the amino acids that are adjacent in the primary structure are a predetermined distance apart in the target graph.

7. The method of claim 6 wherein the predetermined distance is determined via at least one of theoretical calculations and experimental results.

8. The method of claim 6 wherein the predetermined distance is approximately the same for all amino acids forming the protein that are adjacent in the primary structure.

9. The method of claim 6 wherein the predetermined distance is a function of at least one of relative physical size of pairs of the amino acids forming the protein and chemical interactions between pairs of amino acids.

10. The method of claim 5 wherein the interaction energy Hamiltonian term includes terms associated with all pairs of the amino acids forming the protein that are non-adjacent in the primary structure.

11. The method of claim 5 wherein the co-occupation energy Hamiltonian term is minimized for native structures where no two of the amino acids forming the protein are assigned to the same location.

12. The method of claim 1 wherein generating an energy function based at least in part on the at least one assigned location in the target graph includes generating an energy function including a Hamiltonian term based on permissible spatial conformations of subsets of the amino acids from the primary structure of the protein.

13. The method of claim 1, further comprising:
creating the target graph, wherein the target graph has a size sufficient to permit embedding of all possible native multi-dimensional topologies of the protein.

14. The method of claim 1 wherein evolving the analog processor from the initial state to a final state occurs a plurality of times via at least one of adiabatic evolution, quasi-adiabatic evolution, annealing by temperature, annealing by magnetic field, and annealing of barrier height.

15. The method of claim 1, further comprising:
creating the target graph, wherein the target graph is a D-dimensional hypercube having a side length G.

16. The method of claim 1, further comprising:
reading out the final state of the analog processor as a set of bit strings representing the respective locations representing respective ones of the amino acids in the predicted native multi-dimensional geometry.

17. The method of claim 1 wherein evolving the analog processor from an initial state to a final state includes evolving the analog processor to a ground state of the energy function.

18. The method of claim 1 wherein the final state of the energy function corresponds to the native multi-dimensional geometry of the protein.

19. The method of claim 1, further comprising:
reducing a degree of a term of the energy function.

20. The method of claim 1 wherein at least a portion of one of the creating, assigning, generating, mapping and predicting includes operating a digital processor.

21. The method of claim 1 wherein the analog processor comprises a plurality of quantum devices spatially arranged in an interconnected topology, and a plurality of coupling devices between pairs of quantum devices and wherein mapping the energy function onto the analog processor includes programming at least a portion of the quantum devices and the coupling devices to set an energy function of the analog processor.

22. The method of claim 21 wherein the interconnected topology is a two-dimensional grid.

23. A computer program product for use with a computer system for predicting native structures of proteins, the computer program product comprising a computer readable storage medium and a computer program mechanism embedded therein, the computer program mechanism comprising:
instructions for determining a primary structure of a protein, the primary structure indicative of a linear ordered sequence of amino acids forming the protein;
instructions for assigning at least one location in a target graph to represent a respective one of the amino acids forming the protein;
instructions for generating an energy function based at least in part on the at least one assigned location in the target graph;
instructions for mapping the energy function onto an analog processor;
instructions for initializing the analog processor to an initial state;
instructions for evolving the analog processor from the initial state to a final state; and
instructions for receiving an output from the analog processor, the output comprising a predicted native structure representing a multi-dimensional geometry of the protein.

24. The computer program product of claim 23, the computer program mechanism further comprising:
instructions for creating the target graph.

25. A computer system for predicting native structures of proteins, the computer system comprising:
a central processing unit; and
a memory, coupled to the central processing unit, the memory storing at least one program module, the at least one program module encoding:
instructions for determining a primary structure of a protein, the primary structure indicative of an ordered sequence of a plurality of amino acids forming the protein;
instructions for creating a target graph;
instructions for assigning at least one location in the target graph to represent a respective one of the amino acids forming the protein;
instructions for generating an energy function based at least in part on the at least one assigned location in the target graph;
instructions for mapping the energy function onto an analog processor;
instructions for initializing the analog processor to an initial state;
instructions for evolving the analog processor from the initial state to a final state; and
instructions for receiving an output from the analog processor, the output comprising a predicted native structure of the protein, the native structure representing a multi-dimensional geometry of the protein.

26. A computer program product for use with a computer system for predicting native structures of proteins, the computer program product comprising a computer readable storage medium and a computer program mechanism embedded therein, the computer program mechanism comprising:
instructions for determining a primary structure of a protein, the primary structure indicative of an ordered sequence of a plurality of amino acids forming the protein;
instructions for creating a target graph;
instructions for assigning at least one location in the target graph to represent a respective one of the amino acids forming the protein;
instructions for generating an energy function based at least in part on the at least one assigned location in the target graph;
instructions for mapping the energy function onto an analog processor;
instructions for initializing the analog processor to an initial state;
instructions for evolving the analog processor from the initial state to a final state; and
instructions for receiving an output from the analog processor, the output comprising a predicted native structure of the protein, the native structure representing a multi-dimensional geometry of the protein.

27. A data signal embodied on a carrier wave, comprising a predicted native structure of a protein, the predicted native structure obtained according to a method comprising:
determining a primary structure of a protein, the primary structure indicative of an ordered sequence of a plurality of amino acids forming the protein;
creating a target graph;
assigning at least one location in the target graph to represent a respective one of the amino acids forming the protein;
generating an energy function based at least in part on the at least one assigned location in the target graph;
mapping the energy function onto an analog processor;
evolving the analog processor from an initial state to a final state; and
predicting the native structure of the protein based on the final state of the analog processor, the native structure representing a multi-dimensional geometry of the protein.

28. The data signal of claim 27 wherein the data signal is encrypted.

29. A system for predicting native structures of proteins, the system comprising:
a primary structure module for determining a primary structure of a protein, the primary structure indicative of an ordered series of amino acids forming the protein;
a target graph creation module for creating a target graph;
an assignment module operable to assign at least one location in the target graph to represent a respective one of amino acids forming the protein;
an energy function module for generating an energy function based at least in part on the at least one assigned location of the target graph;
a mapping module for mapping the energy function onto an analog processor;
an evolution module for evolving the analog processor from an initial state to a final state; and
an output module for outputting a predicted native structure of the protein based on the final state of the analog processor, the native structure representing a multi-dimensional geometry of the protein.

30. The system of claim 29 wherein:
the analog processor includes a plurality of quantum devices spatially arranged in a two-dimensional grid and a plurality of coupling devices, each coupling device in the plurality of coupling devices coupling a pair of quantum devices;
the initialization module includes a quantum device control system configured to set an initial state of at least one of the quantum devices to a predetermined state and a coupling device control system configured to set an initial state of at least one coupling device to the predetermined state;
the receiver module comprises a readout device configured to read out the final state of at least one of the quantum devices.

31. The system of claim 29 wherein the predetermined state is such that the initialization module can repeatably initialize at least one of the quantum device control system and the coupling device control system into a ground state of the predetermined state.

32. The system of claim 29, further comprising:
a digital processor in communication with at least one of the primary structure module, the target graph module, the assignment module, the energy function module, the mapping module, the evolution module and the output module.

33. The system of claim 29, further comprising:
a decomposition module to decompose the energy function such that after being decomposed the energy function is capable of being mapped onto the analog processor.

34. A graphical user interface for depicting a predicted native structure of a protein, the graphical user interface comprising a first display field for displaying the predicted native structure, the predicted native structure obtained by a method comprising:
determining a primary structure of a protein, the primary structure indicative of an ordered series of amino acids forming the protein;
creating a target graph;
assigning at least one location of the target graph to a respective one of the amino acids forming the protein;
generating an energy function based at least in part on the at least one assigned location of the target graph;
mapping the energy function onto an analog processor;
evolving the analog processor from an initial state to a final state; and
predicting the native structure of the protein based on the final state of the analog processor, the native structure representing a multi-dimensional geometry of the protein.

35. The graphical user interface of claim 34, further comprising:
a second display field for displaying the energy function.
